(19) United States
(12) Patent Application Publication
(10) Pub. No.: US 2021/0023681 A1
(43) Pub. Date: Jan. 28, 2021

(54) FABRIC RETAINING DEVICE WITH SWITCHABLE MAGNET

(71) Applicants: Paul Cushman Robinson, JR., Arlington, VA (US); Marissa Munoz Robinson, Arlington, VA (US)

(72) Inventors: Paul Cushman Robinson, JR., Arlington, VA (US); Marissa Munoz Robinson, Arlington, VA (US)

(21) Appl. No.: 16/870,709

(22) Filed: May 8, 2020

Related U.S. Application Data
(60) Provisional application No. 62/876,929, filed on Jul. 22, 2019.

(51) Int. Cl. B25B 11/00; D05C 9/04

(52) U.S. Cl. CPC B25B 11/002; D05D 2207/06; D05C 9/04

(57) ABSTRACT

A device for use with an embroidery machine holds fabric to be embroidered between upper and lower hoops that are secured to one another by at least one switchable magnet. The switchable magnet is provided on one or more of the upper loop or lower hoop. Multiple switchable magnets may be spaced around a perimeter of the upper loop or lower hoop. One of the hoops may include interchangeable arms for attaching the device to various embroidery machines.

### CROSS REFERENCE TO RELATED APPLICATION

This application claims the benefit of U.S. Provisional Patent Application No. 62/876929, filed on Jul. 22, 2019, the contents of which are hereby incorporated by reference.

### BACKGROUND

### 1. Field

The present disclosure generally relates to a fabric retaining device that incorporates at least one switchable magnet that provides a user-adjustable magnetic force to hold and secure fabric or other object.

### 2. Background

Various fabrics, such as material for garments, bedding, upholstery, luggage, industrial applications, etc., may be secured to a fabric retaining device and, in turn, the fabric retaining device may be coupled to a device to process the fabric. For example, in the field of embroidery, an automated embroidery device applies thread to generate a pattern on a secured section of the fabric. The fabric retaining device are referred to herein as hoops having interior openings where fabric is received, but may have different shapes and may be referred to by different terms, such as frames or clamps.

The fabric retaining hoops may include an upper hoop and a lower hoop having central openings, and the upper and lower hoops may be mated together to secure the fabric. For example, the fabric may be placed on the lower hoop, usually with a backing material, and the upper hoop is placed over the fabric and coupled to the lower hoop to secure the composite fabric material. For example, a portion of the fabric may be secured between the vertical sides of the upper and lower hoops to prevent the fabric from moving during processing and to hold the secured portion of fabric in a taut state.

As described in U.S. Pat. Nos. 7,607,399, 7,918,169, and, 8,661,995, the hoops may be coupled together using one or more magnets. Magnets having a relatively strong magnetic force, such as rare earth style magnets, may be used to securely couple the top and bottom hoops and to firmly secure the fabric. However, the strong magnetic forces may cause the top and bottom hoops to be difficult to separate when adjusting the fabric or releasing the fabric after processing. Also, the strong magnetic forces from the magnets may cause the top and bottom hoops to close with significantly large force and speed that a user may be injured or the fabric may be damaged between the hoops.

The above references are incorporated by reference here where appropriate for appropriate teachings of additional or alternative details, features, and/or technical background.

### BRIEF DESCRIPTION OF THE DRAWINGS

Various embodiments will be described in detail herein with reference to the following drawings in which like reference number refer to like elements, wherein:

FIG. 1 shows a cross-section view of a fabric retaining device that includes one or more switchable magnets according to an embodiment of the present disclosure;

FIGS. 2A and 2B show examples of an upper hoop included in the fabric retaining device of FIG. 1 according to an embodiment of the present disclosure;

FIGS. 3A and 3B show examples of a lower hoop included in the fabric retaining device of FIG. 1 according to an embodiment of the present disclosure;

FIGS. 4A-4C show schematic views of a switchable magnet used in the fabric retaining device of FIG. 1 according to an embodiment of the present disclosure;

FIG. 5 shows magnet switch used in the fabric retaining device of FIG. 1 according to an embodiment of the present disclosure; and

FIG. 6 shows a method for handling fabric using the fabric retaining device of FIG. 1 according to an embodiment of the present disclosure.

### DETAILED DESCRIPTION

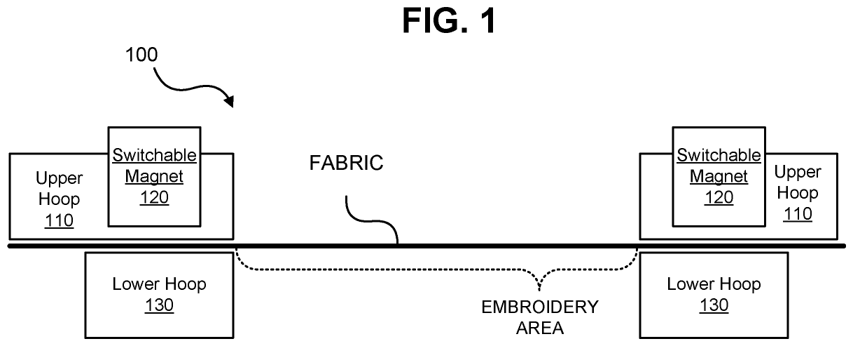

FIG. 1 depicts cross-section view of a fabric retaining device 100 according to an embodiment of the present disclosure. The fabric retaining device 100 includes an upper (or main) hoop 110 that includes one or more switchable magnets 120 and a lower (or bottom) hoop 130 to receive and position a fabric for processing, such as for embroidery. As described below, the switchable magnets 120 may be adjusted to selectively engage the lower hoop 130 to couple the upper hoop 110 and the lower hoop 130.

As shown in FIG. 1, the lower hoop 130 may be positioned below the fabric, and the upper hoop 110 may be positioned over the fabric. While the upper hoop 110 is described as including the switchable magnets 120, it should be appreciated that the switchable magnets 120 may be provide on the lower loop 130 or on another structure, such as an intermediate structure. The switchable magnets 120 may be magnetically attracted to the lower hoop 130 through the fabric to couple the upper hoop 110 to the lower hoop 130 to secure a portion of the fabric. Each of the upper hoop 110 and bottom hoop 130 may have a generally circular or other hollow-shape that forms a central opening to provide an area where the secured fabric material will be embroidered when the upper and bottom hoops 110, 130 are coupled together. A gap between the upper hoop 110 and the lower hoop 130 may be automatically adjusted to handle fabrics of different thicknesses. The upper hoop 110 and the lower hoop 130 may include one or more vertical extensions, such as rings or posts, that interact with each other to position the upper hoop 110 and the lower hoop 130.

As described in greater detail below, the switchable magnets 120 may provide a user-adjustable magnetic force, and the switchable magnet 120 may be used to modulate the clamping force between the upper hoop 110 and the bottom hoop 130. For example, the switchable magnet may be placed into a minimum magnetic force state (e.g., a magnet off state) when user's fingers are positioned between the upper hoop 110 and the bottom hoop 130, when fabric is being inserted or a position of the fabric is being adjusted, or to separate the upper hoop 110 and the bottom hoop 130 to remove the fabric after embroidery. At least one switchable magnet 120 may be placed into a maximum magnetic force state (e.g., a magnet on state) to securely hold the fabric during embroidering. In other examples, a switchable magnet 120 may be placed in an intermediate magnetic force state that is between the minimum and the maximum magnetic force states. In yet another example, a switchable magnet 120 may be placed in a reverse magnetic force state in which the switchable magnet 120 supplies a force to push the upper hoop 110 away from the lower hoop 130.

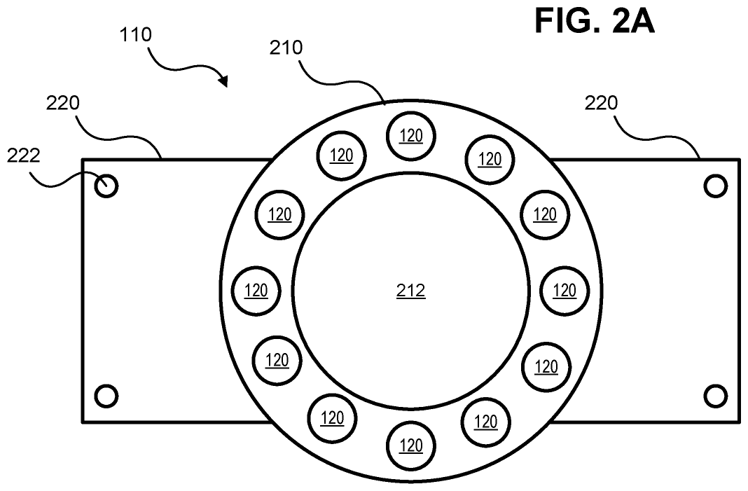

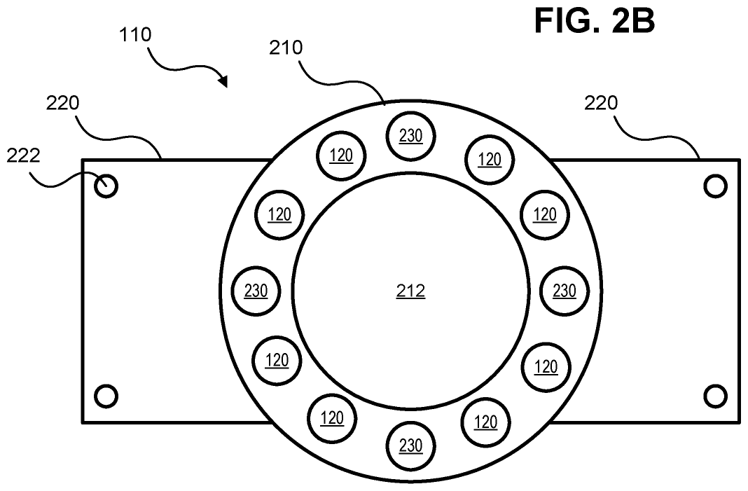

FIGS. 2A and 2B show top views of the upper hoop 110 according to embodiments of the present disclosure. The upper hoop 110 may include an upper hoop body 210 that supports the switchable magnets 120 and forms an opening 212, which provides an area where the fabric will be embroidered. The upper hoop body 210 may be composed of a rigid material of sufficient strength, such as a non-magnetic metal including stainless steel or aluminum, to secure the fabric under tension.

The upper hoop body 210 is shown as having a circular shape to provide a circular upper opening 212 and to have a substantially even thickness in a radial direction. In other examples, the upper hoop body 210 may have a rectangular or other outer shape of form. Likewise, the different sections of the upper hoop body 210 may have different thickness in a different directions to allow the upper hoop body 210 to form the opening 212 with various shapes and sizes. For example, certain regions of the upper hoop body 210 may be formed relatively thicker than other regions to provide desired stiffness in certain directions while allowing greater flexibility in other directions, as desired for embroidery.

In the example shown in FIG. 2A, the switchable magnets 120 may be symmetrically positioned around the opening 212. For example, twelve switchable magnets 120 may be positioned around the opening 212 at an angular spacing of approximately 30 degrees around a central point in the opening 212. Various combinations of the twelve switchable magnets 120 may be selectively activated to control the clamping force between the upper 110 and lower hoop 130. For example, a pair of the switchable magnets 120, that are separated by five inactive switchable magnets 120 in a circumferential direction, may be activated to provide a clamping force that is one-sixth of a total possible clamping force provided when all of the switchable magnets 120 are active. Similarly, activating three, four, or six of the switchable magnets 120 that are separated by inactive switchable magnets 120 may provide clamping forces that are, respectively, one-fourth, one-third, or a half of the total force provided when all of the switchable magnets 120 are active. It should be appreciated that different quantities of the switchable magnets 120 may be used, and the positioning of the switchable magnets 120 on the upper hoop body 210 may vary, as desired. For example, the switchable magnets 120 may be provided more densely in certain portions of the upper hoop body 210 (e.g., away from arms 220 to be described below) to hold the fabric more securely in these portions of the of the upper hoop body 210.

The upper hoop 110 may include one or more arms 220 that extend from the upper hoop body 210. The arms 220 are shaped and may include one or more connection holes 222 to receive a connector, such as a screw or bolt, to couple the upper hoop 110 to an embroidery machine. Different mounting arms 220 can be attached to the upper hoop body 210 to allow the upper hoop 110 to fit different types, brands, or modes of embroidery machines. In other examples, additional or different structures (not shown), such as adaptor frames connecting the arms 220 to the embroidery machine, may be used to position and secure the upper hoop 110.

In one implementation shown in FIG. 2B, the upper hoop 110 may also include one or more fixed magnets 230 supported by the upper hoop body 210. As used herein, a “fixed” magnet 230 may refer to a magnet that does not have a switchable magnetic force (e.g., a magnet that is always active). For example, a portion of the magnets supported on the upper hoop body 210 may be fixed magnets 230 while other magnets supported on the upper hoop body 210 may be switchable magnets 120 to provide reduced costs and complexity. In this example, the switchable magnets 120 may be switched to an off state while the fixed magnetics 230 still attract the lower hoop to reduce the clamping force between the upper hoop 110 and the lower hoop 130. For example, FIG. 2B shows a configuration in which one-third (e.g., 4 of 12) of the total magnets on the upper hoop body 210 are fixed magnetics 230 such that only a third of clamping force is provided between the ⅓ the upper hoop body 210 and the lower hoop 130 when the switchable magnets 120 are deactivated.

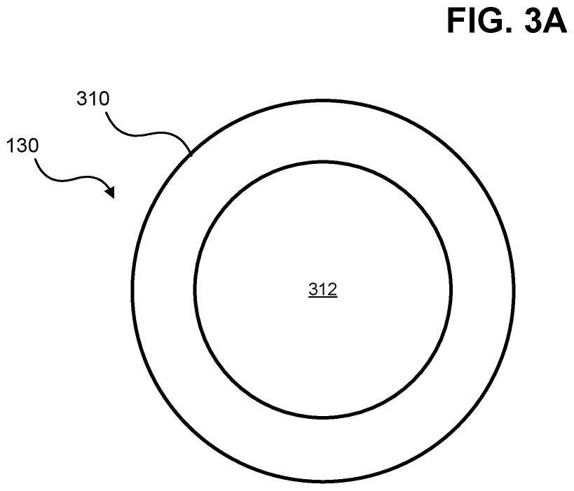

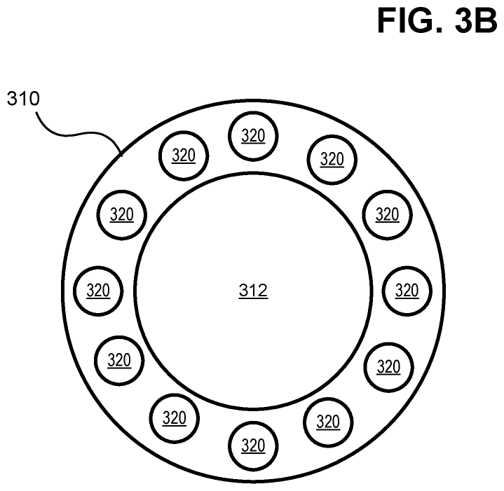

FIGS. 3A and 3B show top views of the lower hoop 130 according to embodiments of the present disclosure. The lower hoop 130 may include a lower hoop body 310 that forms an opening 312, which provides an area where the fabric will be situated. The lower hoop body 310 may be composed of iron, cobalt, nickel, gadolinium, neodymium and samarium and/or alloys composed of these ferromagnetic metals that are strongly attracted to the active switchable magnets 120 and/or the fixed magnets 230 to couple with the upper hoop body 210 to secure the fabric under tension. It should be appreciated that the lower hoop 130 may include additional components, such as arms or other structures to couple the lower hoop body 310 to an embroidery machine.

As shown in FIGS. 3A and 3B, the lower hoop body 310 may also have a generally circular body, and the opening 312 may be designed to mate with the upper opening of the upper hoop 110. For example, the lower opening 312 of the lower hoop 130 may correspond to or be slightly larger than the upper opening 212 of the upper hoop. Although not shown, the bottom hoop may also include one or more mounting arms to be coupled to an embroidery machine.

The lower hoop body 310 is shown as having a circular shape to provide a circular lower opening 312 and to have a substantially even thickness in a radial direction. In other examples, the lower hoop body 310 may have a rectangular or other outer shape of form. Likewise, the different sections of the lower hoop body 310 may have different thickness in a different directions to allow the lower hoop body 310 to form the lower opening 312 with various shapes and sizes. For example, certain regions of the lower hoop body 310 may be formed relatively thicker than other regions to provide desired stiffness in certain directions while allowing greater flexibility in other directions.

In an implementation shown in FIG. 3B, the lower hoop body 310 may be composed of a material, such as plastic, that is not strongly attracted to magnets and include one or more attachment points 320 that are positioned to engage the switchable magnets 120 and/or the fixed magnets 230 to couple the lower hoop body 310 with the upper hoop body 210. For example, the attachment points 320 may include magnets or iron, cobalt, nickel, gadolinium, neodymium and samarium and/or alloys composed of these ferromagnetic metals that are strongly attracted to magnets.

The attachment points 320 of the lower hoop body 310 may have magnets which are designed to attract magnets of the upper hoop 110. Alternatively, attachment points 320 of the lower hoop body 310 may include one or more switchable magnets 120. For example, one or more switchable magnets 120 may be provided on the lower hoop 130 and not the upper hoop 110. In one example, the switchable magnet 120 on the lower hoop body 310 may be rotated or otherwise adjusted by a component of the upper hoop 110, such as rotatable permanent magnet included in the upper hoop 110.

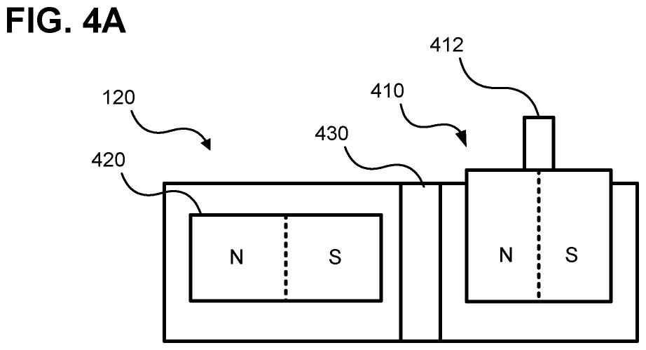

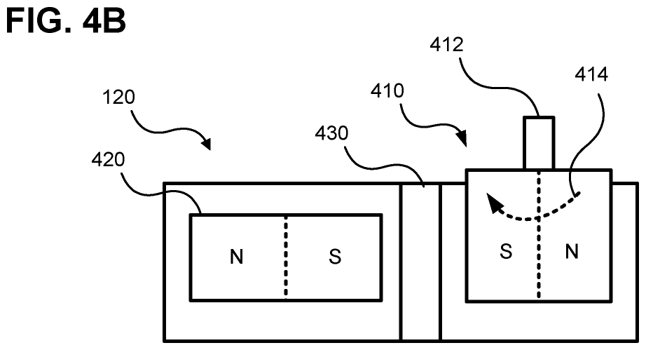

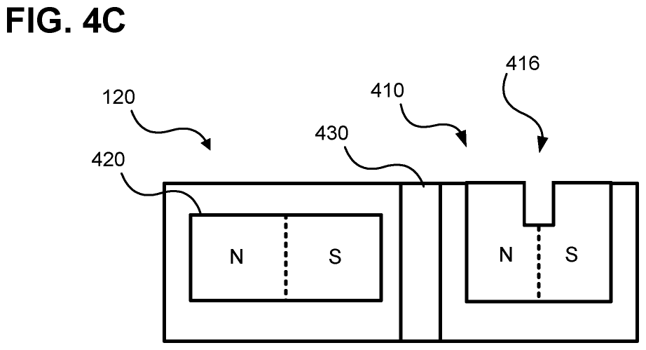

FIGS. 4A-4C show schematic views of a switchable magnet 120. The switchable magnet 120 may include, for example, a movable sub magnet 410 having two or more poles (e.g., north and south poles) and a fixed sub magnet 420 having two or more poles (e.g., north and south poles). A spacer 430, such as a steel pin, may be positioned between the movable sub magnet 410 and the fixed sub magnet 420. For example, fixed sub magnet 420 may be positioned such that one pole (e.g., the south pole (S) in FIGS. 4A and 4B) is oriented toward spacer 430 and the movable sub magnet 410 while another pole (e.g., the north pole (N) in FIGS. 4A and 4B) is oriented away from the spacer 430 and the movable sub magnet 410. In another example, the movable sub magnet 410 may be placed in an intermediate position (e.g., a partial overlap of the north and south poles) to apply an intermediate magnetic force. It should be appreciated that other types of switchable magnets 120, such as a switchable magnet having different sub-magnets or differently positioned sub-magnets or an electromagnets having a magnetic field that varies based on a supplied current or charge, may be used without departing from the general principles of the present disclosure.

The movable sub magnet 410 may be moved based on a user input to vary locations of the poles of the movable sub magnet 410. For example, the movable sub magnet 410 may be designed to rotate along path 414 so that the north and south poles are moved within the upper hoop body 210 and relative to the spacer 430 and the fixed sub magnet 410. For example, FIG. 4B depict a magnet off state in which the poles of the movable sub magnet 410 are positioned such that a pole (shown as south pole (S)) is positioned adjacent to an opposite pole (shown as south pole (S)) of the fixed sub magnet 420. In this position, the charges of the movable sub magnet 410 and the fixed sub magnet 420 would substantially offset each other such that the switchable magnet 120 would provide a relatively lower magnetic attraction to the lower hope 130.

In contrast, FIGS. 4A and 4C depicts a magnet on state in which the poles of the movable sub magnet 410 are positioned such that a pole (south pole (S) in FIG .4B) is positioned adjacent to a similarly charged pole (north pole (N)) of the fixed sub magnet 420. In this orientation, the charges of the movable sub magnet 410 and the fixed sub magnet 420 would augment each other such that the switchable magnet 120 would provide a relatively large magnetic attraction to the lower hope 130.

In FIGS. 4A and 4B, the movable sub magnet 410 may include a gripping protrusion 412 that is configured to be contacted by and rotated by in a user to move one of the sub-magnets. The protrusion 412 may be configured to have a sufficiently low height so that the protrusion 412 does not extend to contact or otherwise interfere with operation of an automatic embroidery machine.

The protrusion 412 of the movable sub magnet 410 may have a shaped profile, such as a rectangle, oval, rhombus, arrow, etc. The orientation and shape of the protrusion of the rotatable magnet may provide an indication of the current magnetic state of the switchable magnet 120. For example, with a rectangle-shaped protrusion head, the movable sub magnet 410 may be in a high magnetic force state (e.g., so that the upper hoop 110 engages the bottom hoop 130) when the rectangle-shaped protrusion head is aligned with an adjacent side of the upper hoop 110 and may be in a low force state (e.g., so that the upper hoop releases from the bottom hoop) when the rectangle-shaped protrusion 412 is substantially perpendicular to or otherwise not aligned with the adjacent side of the upper hoop 110. Similarly, the angle between the rectangle-shaped protrusion 412 and the adjacent side of the upper hoop 110 may provide an indication when the selectable magnet 120 is in an intermediate state to provide less than a maximum magnetic force, and the amount of intermediate force being applied by the selectable magnet.

In another example, the movable sub magnet 410 may be configured to receive and be rotated by a key or other tool. For example, as shown FIG. 4C, a top surface of the movable sub magnet 410 may include a depression 416 to receive a shaped end of the user key or other tool to be inserted into the depression 416. For example, the end of a key may include a magnet that is magnetically aligned to engage the depression 416 of the switchable magnet 120.

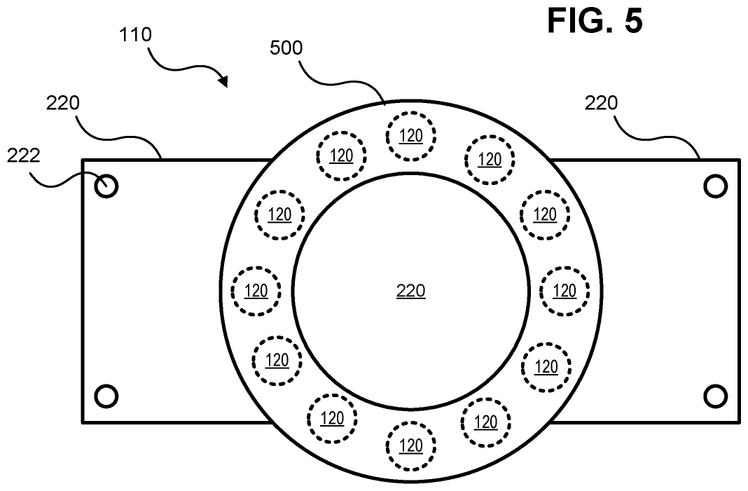

While a switchable magnet 120 is described as being individually switched through different states based a rotation or other movement of the movable sub magnet 410, in another example shown in FIG. 5, multiple switchable magnets 120 may be concurrently switched based on a movement of a switch ring 500. In one example, the switch ring 500 may include a surface defining an internal gear that engages gears formed on external surfaces of the switchable magnets 120 to concurrently rotate the switchable magnets 120 as planetary gears when the switch ring 500 is rotated. In another example, the switch ring 500 may include a surface that engages an external surface of a subset (e.g., one) of the switchable magnets 120, and the subset of the switchable magnets 120 rotated by the switch ring 500 may be further coupled by a sun gear to rotate other switchable magnets 120. The switch ring 500 may include a protrusion or depression to receive a force to move the switch ring (e.g., to rotate around the opening 212) relative to the upper hoop 120.

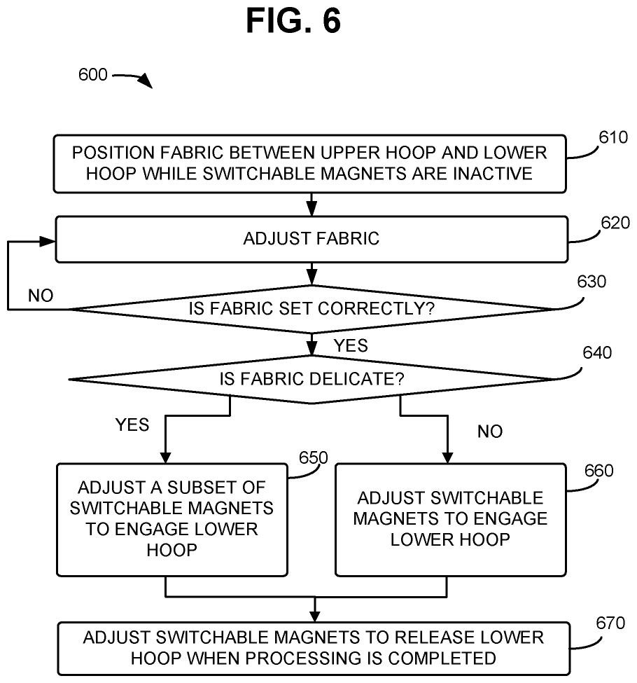

FIG. 6 is a flow diagram illustrating a fabric securing process 600 for securing fabric for processing. In one implementation, process 600 may be implemented using the fabric securing device 100. In other implementations, process 600 may be performed by one or more other devices having at least one switchable magnet 120.

As shown in FIG. 6, process 600 may position a fabric between the upper and lower hoops when the switchable magnet is set in an inactive state such that the upper and lower hoops are not strongly coupled together (block 610), and adjusting the fabric between upper and lower hoops (block 620). For example, in block 620, the fabric may be adjusted to remove any creases and to correctly position the fabric in openings of the upper and lower hoops. The fabric may be evaluated to determine whether the fabric is correctly set (block 630), and if the fabric is not correctly set (block 630-No), process 600 may return to block 620 for additional adjustment of the fabric, as needed.

If the fabric is correctly set (block 630-Yes), a determination is made regarding whether the fabric is delicate (block 640). For example, a user may determine whether the fabric include certain type of materials, has a fine structure, or has previous damage that may make the fabric susceptible to damage when high clamping pressure is applied between the upper and lower hoops. If the fabric is delicate (block 640-Yes), a subset of the switchable magnets may be activated to couple the upper and lower hoops with a partial clamping force (block 650). If the fabric is not delicate (block 640-No), all of the switchable magnets may be activated to couple the upper and lower hoops with a full clamping force (block 660). When the embroidery of the secured fabric is completed, the switchable magnets activated in blocks 650, 660 may be switched off to uncouple the upper and lower hoops and to remove the fabric (block 670).

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A device comprising:
a first hoop defining a first opening; and
a second hoop defining a second opening,
wherein the first hoop includes a plurality of magnets that are spaced apart, and the magnets include at least one switchable magnet that has an adjustable magnetic force,
wherein the second hoop includes a material to attract the magnets of the first hoop such that fabric is retained between the first opening and the second opening by magnetic attraction between the magnets of the first hoop and the second hoop.

2. The device of claim 1, wherein the second hoop includes a metal material to attract the magnets of the first hoop.

3. The device of claim 1, wherein each of plurality of magnets included in the first hoop is a switchable magnet.

4. The device of claim 4, wherein the first hoop includes twelve switchable magnets, adjacent pairs of switchable magnets being separated by a substantially common angular distance.

5. The device of claim 1, wherein the switchable magnet is adjustable between a magnet on state and a magnet off state.

6. The device of claim 5, wherein the switchable magnet includes a fixed sub-magnet and a movable sub-magnet, the switchable magnet being between the magnet on state and the magnet off state based on a movement of the movable sub-magnet to align or separate respective poles of the fixed sub-magnet and the movable sub-magnet.

7. The device of claim 6, wherein the switchable magnet includes a steel pin provided between the fixed sub-magnet and the movable sub-magnet.

8. The device of claim 5, wherein the switchable magnet includes a protrusion that is configured to receive a force to move the movable sub-magnet.

9. The device of claim 5, wherein surface of the movable sub magnet includes a depression that is configured to receive a force to move the movable sub-magnet.

10. The device of claim 1, wherein at least one of the first hoop or the second hoops includes at least one arm to attach the device to an embroidery machine.

11. The device of claim 10, wherein the arm is changeable to attach the device to different embroidery machines.

12. The device of claim 1, wherein the magnets include a plurality of switchable magnets, and the device further comprises a switch ring that is positioned over the upper hoop to concurrently engage and move the switchable magnets.

13. A method of securing an object to a device that includes a first frame defining a first opening and supporting a switchable magnet with an adjustable magnetic force, and a second frame defining a second opening, the method comprising:
positioning the object between the first frame and the second frame while the adjustable magnetic force of the switchable magnet is set to not engage the second frame;
adjusting a position of the object in the first opening and the second opening while the adjustable magnetic force of the switchable magnet is set to not engage the second frame;
setting the adjustable magnetic force of the switchable magnet to engage the second frame during processing of the object after the object is correctly positioned in the first opening and the second opening; and
setting the adjustable magnetic force of the switchable magnet to not engage the second frame for removal of the object from the first frame and the second frame after processing of the object.

14. The method of claim 13, wherein the first frame supports a plurality of switchable magnets, and the object is positioned between the first frame and the second frame when each of the switchable magnets is set to not engage the second frame.

15. The method of claim 14, further comprising:
determining whether the object is includes a particular material or is damaged;
when the object the particular material or is damaged, setting a subset of the switchable magnets to engage the second frame during processing of the object; and
when the object does not include the particular material and is not damaged, setting each of the switchable magnets to engage the second frame during processing of the object.

16. The method of claim 13, wherein the switchable magnet includes a fixed sub-magnet and a movable sub-magnet, and adjusting the magnetic force of the switchable magnet includes moving the movable sub-magnet to align or separate respective poles of the fixed sub-magnet and the movable sub-magnet.
